(19) United States
(12) Patent Application Publication
(10) Pub. No.: US 2021/0200490 A1
(43) Pub. Date: Jul. 1, 2021

(54) PREVIEW FOR A PRINT JOB

(71) Applicant: HEWLETT-PACKARD DEVELOPMENT COMPANY, L.P., Spring, TX (US)

(72) Inventors: David M. BERFANGER, Houston, TX (US); Ingeborg TASTL, Houston, TX (US); Miguel Angel LOPEZ, Houston, TX (US)

(73) Assignee: HEWLETT-PACKARD DEVELOPMENT COMPANY, L.P., Spring, TX (US)

(21) Appl. No.: 16/075,678

(22) PCT Filed: Jul. 28, 2017
(86) PCT No.: PCT/US2017/044527

§ 371 Date: Aug. 6, 2018

(51) Int. Cl. G06F 3/12

(52) U.S. Cl. CPC G06F 3/1256; G06F 3/1205; G06F 3/1258

(57) ABSTRACT

A computing system can include a preview module and a display interface. In some examples, the preview module can obtain adjustment values for adjusting an operation for a printer to achieve or form an output of the printer with a set of attributes included in a print job. Additionally, the preview module can generate a preview of the output, based on the adjustment values, the set of attributes and a set of configuration parameters of the display component. In such examples, the preview can be based on the adjustment values, the set of attributes and a set of configuration parameters of the display component. In some examples, the preview module can communicate the preview of the output to a display component using the display interface.

### BACKGROUND

Printer systems are used to create physical output specified by a print job. In some examples, a preview can be provided for the output of a three-dimensional printer system. In other examples, a preview can be provided for the output of a two-dimensional printer system. For example, the preview can present a representation of the attributes of the output.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 illustrates an example computing system to provide a preview of an output of a print job to a display component;

FIG. 2 illustrates an example network computing system to provide a preview of an output of a print job to a display component;

FIG. 3 illustrates an example method for providing a preview of an output of a print job; and

FIG. 4 illustrates a computer system upon which aspects described herein may be implemented.

Throughout the drawings, identical reference numbers designate similar, but not necessarily identical elements. The figures are not necessarily to scale, and the size of some parts may be exaggerated to more clearly illustrate the example shown. Moreover, the drawings provide examples and/or implementations consistent with the description. However, the description is not limited to the examples and/or implementations provided in the drawings.

### DETAILED DESCRIPTION

Examples provide for a computing system to provide a preview or preview content of an output of a printer (e.g., a three-dimensional output object or a two-dimensional output page) on a display component. In some examples, the preview can be based on adjustment values or operational configurations of a printer (e.g., a two-dimensional printer or a three-dimensional printer) when generating an output with a set of attributes specified by a print job. Additionally, in some examples, the preview can be further based on the set of attributes for an output of the printer included in the print job and a set of configuration parameters of the display component. In such examples, the preview can take into account the configuration parameters of the display component to more accurately reflect the output formed by the printer.

Typically, a printer system (e.g., a two-dimensional printer system or a three-dimensional printer system) can generate an output through a selective depositing of print agents (e.g., coloring agents, fusing agents, etc.) on build material based on an attribute (e.g., a mechanical attribute, an appearance attribute, and/or a functional attribute, etc.) of the output specified by a print job. Additionally, each printer system can have its own set of operational limitations or constraints. As such, each printer system forms the output as closely as possible to the attribute specified by the print job under the operational limitations of the printer system. For example, a two-dimensional printer system may generate a two-dimensional page by selectively depositing print agents (e.g., coloring agents) on a medium (e.g., plain paper, a coated paper or a photographic paper), based on the attribute specified by the print job. Additionally, the two-dimensional printer system generates the two-dimensional page as closely as possible to the attribute specified by the print job under its operational constraints. In other examples, a three-dimensional printer system may generate a three-dimensional output object by selectively depositing print agents (e.g., coloring agents, fusing agents, etc.) on a build material, based on the attribute specified by the print job. In some implementations, the build material may be a powder-like granular material, which may for example be a plastic, ceramic or metal powder. Additionally, the three-dimensional printer system generates the output object as closely as possible to the attribute specified in the print job under its operational constraints.

According to some aspects, the printer systems (e.g., a two-dimensional printer system or a three-dimensional printer system) can generate an output based on data models included in the print jobs. A data model may define or specify the desired printed portions or attributes (e.g., mechanical attributes, appearance attributes, functional attributes, etc.) of the output (e.g., two-dimensional page or three-dimensional object). In examples where the printer system is a two-dimensional printer system, the print job can include a two-dimensional page description model. In such examples, a developer can utilize a page layout software to generate the two-dimensional page description model. Additionally, the two-dimensional printer system can process the two-dimensional page description model to generate discrete, rasterized pixel data to define at least a portion of an area of the medium that is to have print agents deposited on by the two-dimensional printer system. In examples, where the printer system is a three-dimensional printer system, the print job can include a data model of a three-dimensional output object to be generated. In such examples, a developer can utilize a computer aided design (CAD) software to generate the data model of the three-dimensional output object. Additionally, the three-dimensional printer system can process the data model to generate parallel slices of the data model, where each slice may define at least a portion of a respective layer of build material that is to be solidified or caused to coalesce by the three-dimensional printer system.

System Description

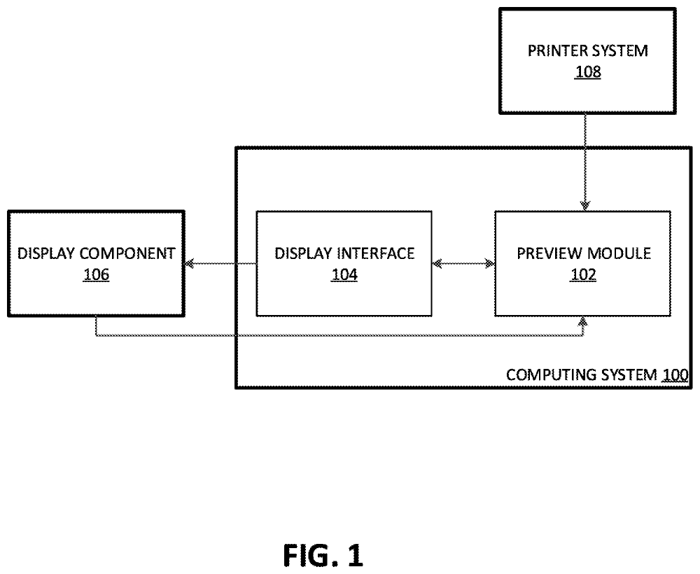

FIG. 1 illustrates an example computing system to provide a preview of an output of a print job to a display component. As illustrated in FIG. 1, computing system 100 can include a preview module 102 and a display interface 104. Preview module 102 can implement processes and other logic to generate a preview or preview content of an output of a print job. As herein described, an “output” can include a three-dimensional output object or a two-dimensional output object (e.g., a two-dimensional output page). The preview can be displayed on display component 106. Additionally, preview module 102 can send or provide the preview content to display component 106 through display interface 104.

In some examples, preview module 102 can take into account, when generating the preview content, operational configurations or the adjustment values of printer system 108 makes to form an output with a set of attributes specified by a print job. The adjustment values can vary from printer system to printer system because each printer of each printer system can have different specifications and resources. In some examples, the adjustment values may be obtained from the printer system (e.g., printer system 108) that is to form the output. In other examples, the adjustment values may be received from a service provider (e.g., an attribute resource system of a manufacturer) that can be remote from printer system 108. As herein described “printer system 108” can refer to a two-dimensional printer system or a three-dimensional printer system. Additionally, “printer” can refer to a two-dimensional printer or a three-dimensional printer.

In some examples, preview module 102 can generate a preview based on the set of attributes for an output of printer system 108 specified in the print job. Examples of a set of attributes of an output include, mechanical attributes (e.g., elongation, tensile strength, impact strength, etc.), appearance attributes (e.g., RGB, CMYK, hue, saturation, lightness, gloss, etc.), and functional attributes (e.g., surface orientation, size, etc.).

Additionally, in other examples, preview module 102 can generate a preview based on a set of configuration parameters of display component 106. In some examples, the configuration parameters of display component 106 can be obtained by preview module 102. Additionally, preview module 102 can utilize the configuration parameters of display component 106 to generate a preview of an output that can be an accurate reflection of the output formed by printer system 108.

In some implementations, the preview content generated by preview module 102 can be based on the type of material (e.g., plastic, ceramic, metallic, etc.) and/or the material properties of the material to be used to form the output. For example, preview content based on a print job indicating usage of a plastic material would have a different visual representation than preview content based on a print job indicating usage of a metallic material. In some examples, the print job can include data indicating the type of material or the material properties of the material to utilized to form the output.

Display interface 104 can receive the preview processed from preview module 102 and provide the preview to display component 106. Display component 106 can present the preview. In some examples, the preview can be provided or displayed on display component 106 of a mobile device of a user. In other examples, the preview can be provided or displayed on display component 106 of a printer of printer system 108.

In some examples, the preview can be updated to reflect a change or an adjustment to an attribute of an output specified by a print job. In such examples, computing system 100 can include an adjustment module to adjust or change an attribute of an output of the preview. In some implementations, the adjustment module can adjust an attribute of an output based on a user input. The user input can indicate an adjustment to be made for an attribute of an output specified by a print job. Additionally, the adjustment module can convert the user input into an attribute value and submit to preview module 102 the attribute value. Preview module 102 can utilize the attribute value converted from the user input to update the associated attribute value of the corresponding attribute of the output specified by the print job.

Printer system 108 can generate an output with the updated attribute. For example, following the previous example, the adjustment module can also send the attribute value converted from the input value to a printer module of computing system 100. Additionally, the printer module can update the attribute value of the corresponding attribute of the output of a received print job with the attribute value converted from the user input. In some examples, the printer module can receive the print job from a mobile computing device wirelessly (e.g., WiFi, Bluetooth, BLE (Bluetooth low energy), NFC, or other appropriate short-range communication). In such examples, computing system 100 can be included in printer system 108. In other examples, the printer module can receive the print job from an appropriate mobile storage device (e.g., SD card, flash drive, etc.).

In some examples, printer system 108 can utilize a default map to determine the appropriate operational parameters (e.g., an appropriate amount of fusing agents, coloring agents and/or build material) for printer system 108 to generate the output. The default map can include predetermined operational parameters for a variety of different attributes. In some examples, based on the default map and the attributes specified by the print job, printer system 108 can determine a set of predetermined operational parameters that corresponds to the attributes of an output, as originally specified in a print job or as adjusted. For example, suppose printer system 108 includes a three-dimensional printer. The default map can include operational parameters for the three-dimensional printer to deposit the right mixture of coloring agents on the build material to achieve the appearance attributes of the output specified by the print job or the adjustments to the color properties specified by a user input. In other examples, the default map can include operational parameters for the three-dimensional printer to deposit the right mixture of build material and agents (e.g., coloring agents and/or fusing agents) to achieve the appearance, mechanical attributes and/or functional attributes of the output specified by the print job or the adjustments to the appearance, mechanical and/or functional attributes specified by a user input. In examples where printer system 108 includes a two-dimensional printer, the default map can include operational parameters for the two-dimensional printer. The default map can include predetermined operational parameters for the two-dimensional printer to deposit the right mixture of coloring agents on the medium to achieve the appearance attributes of the output specified by the print job or the adjustments to the color properties specified by a user input.

In some examples, the default map can be stored locally on printer system 108. In other examples, the default map can be stored remotely. For example, the default map can be stored on a server of a service provider (e.g., an attribute resource component of a manufacturer or service provider). In such examples, printer system 108 can obtain the default map from the service provider. In other examples, the default map can be obtained from a mobile device of a user. In such examples, computing system 100 can first obtain the default map from the service provider.

A user input to adjust an attribute (e.g., a mechanical attribute, an appearance attribute or a functional attribute) of an output of a print job can be based on the interactions of a user with a user interface. In some examples, the user interface can present a set of attribute adjustment options for each attribute of an output specified in a print job. The set of attribute adjustment options can be incremental changes for a corresponding attribute (e.g., each option in the set of attribute adjustment options can incrementally change the lightness attribute of the output).

In some examples, the adjustment options can be based on attribute adjustment information. The attribute adjustment information can include data of a range of adjustments for each attribute (e.g., a mechanical attribute, an appearance attribute, a functional attribute, etc.) of an output. Additionally, the range of adjustments can be based on the specifications and resources of a printer or of printer system 108. In some examples, the attribute adjustment information (including the range of adjustments and the adjustment options derived thereof) can include prepopulated or precalculated attribute adjustment options for each attribute of an output. Additionally, the attribute adjustment information can be based on the specifications and resources of a specific printer that is to generate the output.

Computing system 100 can store attribute adjustment information for a variety of printers (e.g., a variety of two-dimensional printer systems or a variety of three-dimensional printer systems) of different printer systems (e.g., two-dimensional printer systems or three-dimensional printer systems). Alternatively, in other examples, the attribute adjustment information can be stored remotely (e.g. a server of an attribute resource component or a server or printer system 108). In such examples, a user input (e.g., a request to adjust an attribute of the output) or data included in the print job (e.g., request to adjust an attribute of the output or obtainment of the attribute adjustment information) can trigger obtaining of the attribute adjustment information corresponding to the printer or printer system that is to generate the output. The user input or data included in the print job that triggers obtainment of the attribute adjustment information can specify the printer system that is to generate the output.

A user interface to adjust an attribute of an output can be provided with the preview on display component 106. For example, the user interface presenting the attribute adjustment options can be displayed concurrently on a user interface on display component 106. Additionally, an adjustment made to an attribute of an output (e.g., by interacting with the user interface to indicate adjustments for an attribute of an output), the preview can present the corresponding adjustments of the output, based on the techniques previously described. In some examples, the user interface can be provided or displayed on display component 106 of a mobile device of a user. In other examples, the user interface can be provided or displayed on display component 106 of printer system 108.

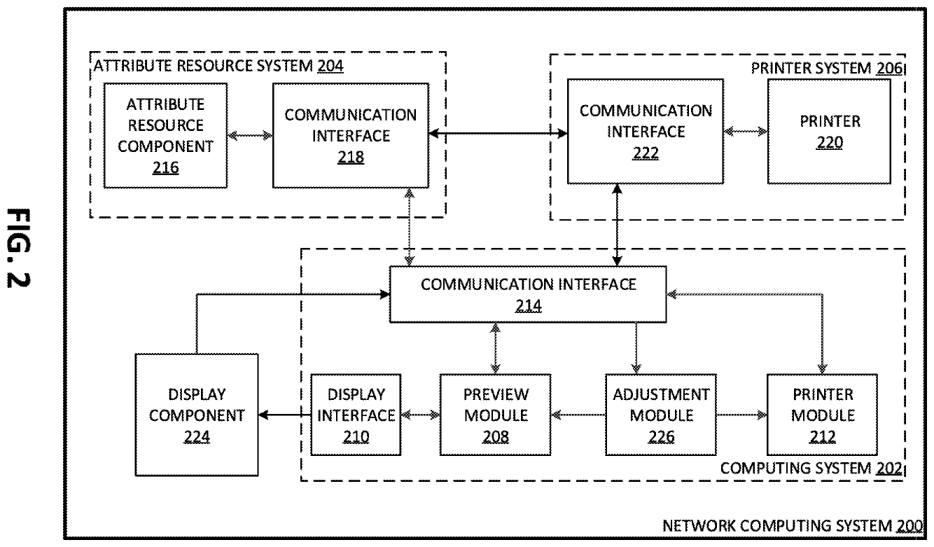

FIG. 2 illustrates an example network computing system to provide a preview of an output of a print job to a display component. As illustrated in FIG. 2, network computing system 200 can include computing system 202, attribute resource system 204, and printer system 206. Computing system 202 can include preview module 208, display interface 210, printer module 212, and communication interface 214. Preview module 208 can implement processes and other logic to generate a preview or preview content of an output. As herein described, an “output” can include a three-dimensional output object or a two-dimensional output object (e.g., a two-dimensional output page). The preview can be displayed on display component 224. Additionally, preview module 208 can send or provide the preview content to display component 224 through display interface 210.

Preview module 208 can take into account when generating the preview content, operational configurations or the adjustment values of printer 220 printer system 206 makes to form an output with a set of attributes specified by a print job. The adjustment values can vary from printer system to printer system because each printer (e.g., printer 220) of printer system (e.g., printer system 206) can have different specifications and resources. In some examples, the adjustment values may be obtained from the printer system (e.g., printer system 206) that is to generate the output. In other examples, the adjustment values may be received from a service provider (e.g., attribute resource system 204 of a manufacturer) that can be remote from the three-dimensional printer system. As herein described “printer system 206” can refer to a two-dimensional printer system or a three-dimensional printer system. Additionally, “printer 220” can refer to a two-dimensional printer or a three-dimensional printer.

In some examples, preview module 102 can generate the preview on the set of attributes for an output specified in the print job. Examples of a set of attributes of an output include, mechanical attributes (e.g., elongation, tensile strength, impact strength, etc.), appearance attributes (e.g., RGB, CMYK, hue, saturation, lightness, gloss, etc.), and functional attributes (e.g., surface orientation, size, etc.).

Additionally, in other examples, preview module 208 can generate the preview on a set of configuration parameters of display component 224. In some examples, the configuration parameters of display component 224 can be obtained by preview module 208. Additionally, preview module 208 can utilize the configuration parameters of display component 224 to generate a preview of an output that can be an accurate reflection of the output formed by printer 220.

In some implementations, the preview content generated by preview module 208 can be based on the type of material (e.g., plastic, ceramic, metallic, etc.) and/or the material properties of the material to be used to generate the output. For example, preview content based on a print job indicating usage of a plastic material would have a different visual representation than preview content based on a print job indicating usage of a metallic material. In some examples, the print job can include data indicating the type of material or the material properties of the material to utilized to generate the output.

Display Interface 210 can obtain the preview processed from preview module 208 to provide the preview to display component 224 for display. In some examples, the user interface can be provided or displayed on display component 224 of a mobile device of a user. In other examples, the user interface can be provided or displayed on display component 224 of printer 220 of printer system 206.

In some examples, the preview content can be updated to reflect a change or an adjustment to an attribute of an output specified by a print job. In such examples, computing system 100 can include adjustment module 226 to adjust or change an attribute of an output of the preview. In some implementations, adjustment module 226 can adjust an attribute of an output based on a user input (e.g., a user interacting with a user interface provided by display component 224). The user input can indicate an adjustment to be made for an attribute of an output specified by a print job. Additionally, adjustment module 226 can convert the user input into an attribute value and submit to preview module 208 the attribute value. Preview module 208 can utilize the attribute value converted from the user input to update the associated attribute value of the corresponding attribute of the output specified by the print job.

Printer 220 of printer system 206 can generate an output with the updated attribute. For example, following the previous example, adjustment module 226 can also send the attribute value converted from the user input to printer module 212. Additionally, printer module 212 can update the attribute value of the corresponding attribute of the output of a received print job with the attribute value converted from the user input. In some examples, printer module 212 can receive the print job from a mobile computing device wirelessly (e.g., WiFi, Bluetooth, BLE (Bluetooth low energy), NFC, or other appropriate short-range communication). In such examples, computing system 202 can be included in printer system 206. In other examples, printer module 212 can receive the print job from an appropriate mobile storage device (e.g., SD card, flash drive, etc.).

In some examples, printer system 206 can utilize a default map to determine the appropriate operational parameters (e.g., the appropriate amount of fusing agents, coloring agents and/or build material) for three-dimensional printer 206 to generate the output. The default map can include predetermined operational parameters for a variety of different attributes. In some examples, based on the default map and the attributes specified by the print job, printer system 206 can determine a set of predetermined operational parameters that corresponds to the attributes of an output, as originally specified in a print job or as adjusted. Additionally, the default map can correspond to a particular printer system or a particular printer. For example, suppose printer 220 of printer system 206 is a three-dimensional printer. The default map can include operational parameters for that particular three-dimensional printer (e.g., printer 220) to deposit the right mixture of coloring agents to achieve the appearance attributes of the output specified by the print job or the adjustments to the color properties specified by a user input. In other examples, the default map can include operational parameters for the three-dimensional printer (e.g., printer 220) to deposit the right mixture of build material and agents (e.g., coloring agents and/or fusing agents) to achieve the mechanical attributes and/or functional attributes of the output specified by the print job or the adjustments to the mechanical attributes and/or functional attributes specified by a user input. In examples where suppose printer system 108 includes a two-dimensional printer, the default map can include operational parameters for the two-dimensional printer. For, the default map can include predetermined operational parameters for the two-dimensional printer to deposit the right mixture of coloring agents on the medium to achieve the appearance attributes of the output specified by the print job or the adjustments to the color properties specified by a user input.

In some examples, the default map can be stored locally on printer 220 or in a database of printer system 206. In other examples, the default map can be stored remotely. For example, the default map can be stored on a server of a service provider (e.g., attribute resource component 216 of a manufacturer or service provider). In such examples, printer system 206 can separately obtain the default map from attribute resource component 216 (through communication interface 218 and communication interface 222) and any adjustments made to the attributes of the output specified in the print job (e.g., a user input indicating adjusting an attribute of the output) from computing system 202 (through communication interface 214 and communication interface 222). In other examples, printer system 206 can obtain the default map and any adjustments made to the attributes of the output specified in the print job from computing system 206. In such examples, computing system 206 can first obtain the default map from attribute resource system 204, through communication interface 218 and communication interface 216.

A user input to adjust an attribute (e.g., a mechanical attribute, an appearance attribute or a functional attribute) of an output of a print job can be based on the interactions of a user with a user interface. In some examples, the user interface can present a set of attribute adjustment options for each attribute of an output specified in a print job. The set of attribute adjustment options can be incremental changes for the corresponding attribute (e.g., each option in the set of attribute adjustment options can incrementally change the lightness attribute of the output).

The adjustment options can be based on attribute adjustment information. The attribute adjustment information can include data related to the range of adjustments for each attribute (e.g., a mechanical attribute, an appearance attribute, a functional attribute, etc.) of an output. Additionally, the range of adjustments can be based on the specifications and resources of a printer (e.g., printer 220). In some examples, the attribute adjustment information (including the range of adjustments and the attribute adjustments derived thereof) can include prepopulated or precalculated attribute adjustment options for each attribute of an output. Additionally, in such examples, the attribute adjustment information can be based on the specifications and resources of a specific printer that is to generate the output.

Computing system 202 can store attribute adjustment information for a variety of printers (e.g., a variety of three-dimensional printers or a variety of two-dimensional printers) of different printer systems (e.g., three-dimensional printer system or two-dimensional printer system). Alternatively, in other examples, the attribute adjustment information can be stored remotely (e.g. a server of attribute resource component 206 or printer 220 of printer system 206). In such examples, a user input (e.g., a request to adjust an attribute of the output) or data included in the print job (e.g., request to adjust an attribute of the output or obtainment of the attribute adjustment information) can trigger obtainment of the attribute adjustment information corresponding to the printer (e.g., printer 220) that is to generate the output. The user input or data included in the print job that triggers obtainment of the attribute adjustment information can specify the printer (e.g., printer 220) that is to generate the output.

A user interface to adjust an attribute of an output can be provided or presented with the preview content on display component 224. Additionally, an adjustment made to an attribute of an output (e.g., by interacting with the user interface to indicate adjustments for an attribute of an output), the preview content can present the corresponding adjustments of the output, based on the techniques previously described. In some examples, the user interface can be provided or displayed on display component 224 of a mobile device of a user. In other examples, the user interface can be provided or displayed on display component 224 of printer of printer system 206.

Methodology

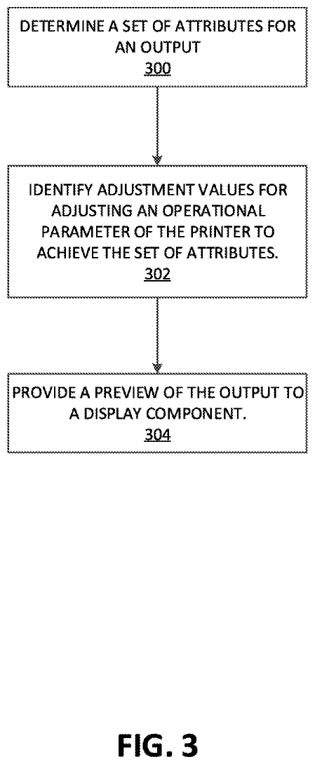

FIG. 3 illustrates an example method for providing a preview of an output of a print job. The below discussion of FIG. 3 may be made to reference characters representing like features as shown and described with respect to FIG. 1 for purposes of illustrating a suitable component for performing the example method being described.

In some examples, computing system 100 can determine from a print job, a set of attributes for an output (300). For example, in some implementations, preview module 102 of computing system 100 can determine a set of attributes for the output specified by the print job. Examples of attributes a print job can specify include mechanical attributes (e.g., elongation, tensile strength, impact strength, etc.), appearance attributes (e.g., RGB, CMYK, hue, saturation, lightness, gloss, etc.), and functional attributes (e.g., surface orientation, size, etc.). In some examples, computing system 100 can obtain a print job wirelessly (e.g., WIFi, Bluetooth, BLE (Bluetooth low energy), NFC, or other appropriate short-range communication) or from an appropriate mobile storage device (e.g., SD card, flash drive, etc.). In other examples, the computing system 100 can obtain a print job via some distributed network (e.g. over the internet using a standard data transfer protocol or a custom data transfer protocol). In such examples, the print job may be received from a user device, a device of a service order vendor, a device of a service provider and/or a device from a print producer.

Computing system 100 can identify adjustment values for adjusting an operational parameter of a printer to achieve the set of attributes (302). In some examples, preview module 102 of computing system 100 can receive adjustment values or operational configurations of a printer to form an output with the set of attributes specified in the print job. Each printer system can have different specifications and resources and as such, the adjustment values of each printer system can vary from printer system to printer system. In some examples, the adjustment values may be obtained from the printer system that is to generate the output. In other examples, the adjustment values may be received from a service provider (e.g., an attribute resource system of a manufacturer) that can be remote from the printer system.

Computing system 100 can provide a preview or preview content of the output to a display component based on the adjustment values, the set of attributes of the output and one or more configuration parameters of the display component (304). For example, preview module 102 generates the preview or preview content based on the adjustment values, the set of attributes of the output and/or one or more configuration parameters of the display component. In some examples, computing system 100 can obtain the configuration parameters of a display component (e.g., display component 106) from the display component. Additionally, preview module 102 can utilize the configuration parameters of a display component (e.g., display component 106) to generate a preview of an output that can be an accurate reflection of the output formed by a printer.

In some implementations, the preview content generated by preview module 102 can be based on the type of material (e.g., plastic, ceramic, metallic, etc.) and/or the material properties of the material to be used to generate the output. For example, preview content based on a print job indicating usage of a plastic material would have a different visual representation than preview content based on a print job indicating usage of a metallic material. In some examples, the print job can include data indicating the type of material or the material properties of the material to utilized to generate the output.

Display interface 106 can receive the preview processed from preview module 102 to provide the preview to display component 106. Display component 106 can present the preview. In some examples, the preview can be provided or displayed on display component 106 of a mobile device of a user. In other examples, the preview can be provided or displayed on display component 106 of a three-dimensional printer of a three-dimensional printer system.

In some examples, the preview or preview content can be updated to reflect a change or an adjustment to an attribute of an output of a print job. In such examples, computing system 100 can include an adjustment module to adjust or change an attribute of an output of the preview. In some implementations, the adjustment module can adjust an attribute of an output based on a user input. The user input can indicate an adjustment to be made for an attribute of an output specified by the print job. Additionally, the adjustment module can convert the user input into an attribute value and submit to preview module 102 the attribute value. Preview module 102 can utilize the attribute value converted from the user input to update the associated attribute value of the corresponding attribute of the output specified by the print job.

A printer of a printer system can generate an output with the updated attributes. For example, following the previous example, the adjustment module can also send the attribute value converted from the input value to a printer module of computing system 100. Additionally, the printer module can update the attribute value of the corresponding attribute of the output of a received print job with the attribute value converted from the user input. In some examples, the printer module can receive the print job from a mobile computing device wirelessly (e.g., WIFi, Bluetooth, BLE (Bluetooth low energy), NFC, or other appropriate short-range communication). In such examples, computing system 100 can be included in the printer of a printer system. In other examples, the printer module can receive the print job from an appropriate mobile storage device (e.g., SD card, flash drive, etc.). In other examples, the printer module can receive the print job from a distributed network (e.g., the internet).

In some examples, a printer can utilize a default map to determine the appropriate operational parameters (e.g., the appropriate amount of fusing agents, coloring agents and/or build material) for the printer to generate the output with the set of attributes specified in the print job. The default map can include predetermined operational parameters for a variety of different attributes. In some examples, based on the default map and the attributes specified by the print job, printer system 108 can determine a set of predetermined operational parameters that corresponds to the attributes of an output, as originally specified in a print job or as adjusted. For example, suppose printer system 108 includes a three-dimensional printer. The default map can include operational parameters for the three-dimensional printer to deposit the right mixture of coloring agents on the build material to achieve the appearance attributes of the output specified by the print job or the adjustments to the color properties specified by a user input. In other examples, the default map can include operational parameters for the three-dimensional printer to deposit the right mixture of build material and agents (e.g., coloring agents and/or fusing agents) to achieve the mechanical attributes and/or functional attributes of the output specified by the print job or the adjustments to the mechanical attributes and/or functional attributes specified by a user input. In examples where printer system 108 includes a two-dimensional printer, the default map can include operational parameters for the two-dimensional printer. The default map can include predetermined operational parameters for the two-dimensional printer to deposit the right mixture of coloring agents on the medium to achieve the appearance attributes of the output specified by the print job or the adjustments to the color properties specified by a user input.

In some examples, the default map can be stored locally on the printer. In other examples, the default map can be stored remotely. For example, the default map can be stored on a server of a service provider (e.g., an attribute resource component of a manufacturer or service provider). In such examples, the printer system can obtain the default map from the service provider. In other examples, the default map can be obtained from a mobile device of a user. In such examples, any adjustments made to the attributes of the output specified in the print job (e.g., a user input indicating adjusting an attribute of the output) can be obtained by the printer system.

A user input to adjust an attribute (e.g., a mechanical attribute, an appearance attribute, a functional attribute, etc.) of an output of a print job can be based on the interactions of a user with a user interface. In some examples, the user interface can present a set of attribute adjustment options for each attribute of an output specified in a print job. The set of attribute adjustment options can be incremental changes for the corresponding attribute (e.g., each option in the set of attribute adjustment options can incrementally change the lightness attribute of the output).

The adjustment options can be based on attribute adjustment information. The attribute adjustment information can include data related to the range of adjustments for each attribute (e.g., a mechanical attribute, an appearance attribute, a functional attribute, etc.) of an output. Additionally, the range of adjustments can be based on the specifications and resources of a printer. In some examples, the attribute adjustment information (including the range of adjustments and the attribute adjustment options derived thereof) can include prepopulated or precalculated attribute adjustment options for each attribute of an output. Additionally, the attribute adjustment information can be based on the specifications and resources of a specific printer that is to generate the output.

Computing system 100 can store attribute adjustment information for a variety of printers of different printer systems. Alternatively, in other examples, the attribute adjustment information can be stored remotely (e.g. a server of an attribute resource component or a server or a printer of a printer system). In such examples, a user input (e.g., a request to adjust an attribute of the output) or data included in the print job (e.g., request to adjust an attribute of the output or obtainment of the attribute adjustment information) can trigger obtainment of the attribute adjustment information corresponding to the printer that is to generate the output. The user input or data included in the print job that triggers obtainment of the attribute adjustment information can specify the printer that is to generate the output.

A user interface to adjust an attribute of an output can be provided with the preview on display component 106. For example, the user interface presenting the attribute adjustment options can be displayed concurrently on a user interface on display component 106. Additionally, an adjustment made to an attribute of an output (e.g., by interacting with the user interface to indicate adjustments for an attribute of an output), the preview can present the corresponding adjustments of the output, based on the techniques previously described. In some examples, the user interface can be provided or displayed on display component 106 of a mobile device of a user. In other examples, the user interface can be provided or displayed on display component 106 of a printer of a printer system.

Hardware Diagram

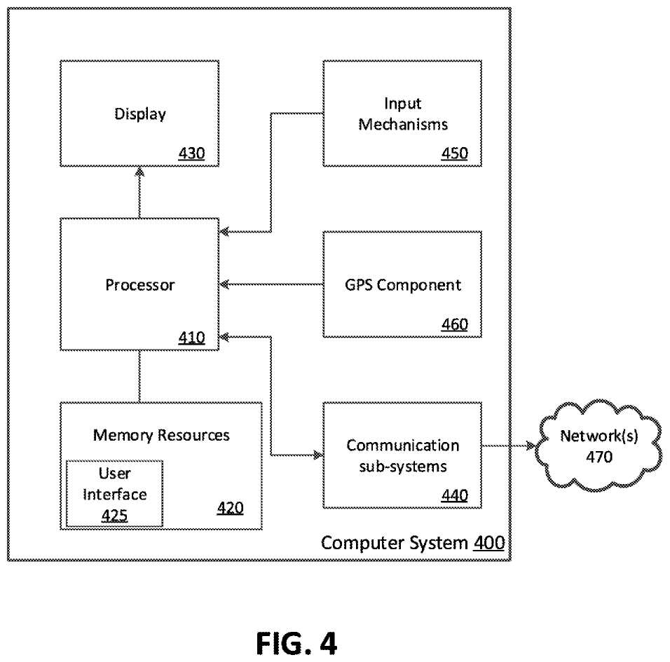

FIG. 4 is a block diagram that illustrates a computer system upon which examples described herein may be implemented. In some examples, a computing device 400 may correspond to a mobile computing device, such as a cellular device that is capable of telephony, messaging, and data services. The computing device 400 can correspond to a device operated by a requester or, in some examples, a device operated by the service provider that provides location-based services. Examples of such devices include smartphones, handsets, tablet devices, or in-vehicle computing devices that communicate with cellular carriers. The computing device 400 includes a processor 410, memory resources 420, a display device 430 (e.g., such as a touch-sensitive display device), one or more communication systems 440 (including wireless communication systems), a sensor set 450 (e.g., accelerometer and/or gyroscope, microphone, barometer, etc.), and one or more location detection mechanisms (e.g., GPS component) 460. In one example, at least one of the communication systems 440 sends and receives cellular data over data channels and voice channels. The communications systems 440 can include a cellular transceiver and one or more short-range wireless transceivers. The processor 410 can exchange data with a service arrangement system (not illustrated in FIG. 4) via the communications systems 440.

The processor 410 can provide a variety of content to the display 430 by executing instructions stored in the memory resources 420. The memory resources 420 can store instructions for the user interface 425. For example, the processor 410 can execute the user interface 425 to read sensor data from one or more sensors 450 of the computing device, and to transmit the sensor data, along with location data of GPS component 560 as local device data to a network computer system (e.g. network computer system 100).

Although specific examples have been illustrated and described herein, it will be appreciated by those of ordinary skill in the art that a variety of alternate and/or equivalent implementations may be substituted for the specific examples shown and described without departing from the scope of the disclosure. This application is intended to cover any adaptations or variations of the specific examples discussed herein.

What is claimed is:

1. A computing system, comprising:
a display interface to:
communicate with a display component;
a preview module to:
obtain adjustment values for adjusting an operation of a printer to achieve a set of attributes for an output of the printer included in a print job;
generate a preview of the output, based on the adjustment values, the set of attributes and a set of configuration parameters of the display component; and
communicate the preview of the output to the display component using the display interface.

2. The computing system of claim 1, wherein the preview module is further to:
enable a user to adjust an attribute of the set of attributes by interacting with a user interface provided with the preview on the display component.

3. The computing system of claim 2, further comprising:
an adjustment module to:
convert a user input into an attribute value using attribute adjustment information, the attribute value corresponding to a first attribute of the set of attributes; and
update the attribute value of the first attribute, wherein the preview module is further configured to update the preview to be based on the updated set of attributes.

4. The computing system of claim 3, wherein the attribute adjustment information is obtained from an attribute resource system.

5. The computing system of claim 2, further comprising:
an adjustment module to:
convert a user input into an attribute parameter using attribute adjustment information, the attribute parameter corresponding to a first attribute of the set of attributes;
update the attribute parameter of the first attribute; and
a printer system interface to:
send the print job including the updated set of attributes to the printer to form the output with the updated set of attributes.

6. The computing system of claim 5, wherein the attribute adjustment information is obtained from an attribute resource system.

7. The computing system of claim 6, wherein the adjustment values are obtained from a printer system.

8. The computing system of claim 7, wherein the printer system is a three-dimensional printer system including a three-dimensional printer.

9. The computing system of claim 8, wherein the set of attributes for an output includes at least one of a mechanical attribute, a functional attribute, and an appearance attribute.

10. A method for operating a preview computer system, the method being implemented by one or more processors and comprising:
determining, from a print job, a set of attributes for an output;
identifying adjustment values associated with a printer; and
providing a preview of the output to a display component based on the adjustment values, the set of attributes and one or more configuration parameters of the display component.

11. The method of claim 10, further comprising:
providing a user interface to enable a user to adjust an attribute of the set of attributes, the user interface being provided with the preview.

12. The method of claim 11, further comprising:
converting a user input into an attribute parameter using attribute adjustment information, the attribute parameter corresponding to a first attribute of the set of attributes; and
updating the attribute parameter of the first attribute.

13. The method of claim 12, further comprising:
updating the preview to be based on the updated set of attributes.

14. The method of claim 12, further comprising:
sending the print job including the updated set of attributes to a printer system to form the output with the updated set of attributes.

15. The method of claim 10, wherein the set of attributes for the output includes at least one of a mechanical attribute, a functional attribute, and an appearance attribute.
